(19) United States
(12) Patent Application Publication
(10) Pub. No.: US 2004/0075554 A1
(43) Pub. Date: Apr. 22, 2004

(54) Luggage location and identification system

(76) Inventor: Roger Yang, Walnut, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/267,920

(22) Filed: Oct. 8, 2002

(51) Int. Cl. G08B 1/08

(52) U.S. Cl. 340/539.32

(57) ABSTRACT

A system for locating and identifying luggage comprising a signaling unit and an identifying unit. The signaling unit includes an electromagnetic signal transmitter electronically coupled to a switch. Actuation of the switch causes the signal transmitter to generate an electromagnetic signal. The identifying unit is affixed to the luggage and includes an electromagnetic signal receiver to receive the electromagnetic signal. The identifying unit further includes a sound producing element electronically coupled to the signal receiver such that the sound producing element emits an identifying sound following receipt of the electromagnetic signal by the signal receiver. The identifying unit may also include an optional light source that emits light following receipt of the electromagnetic signal to further assist in location and identification of the luggage.

### BACKGROUND OF THE INVENTION

1. Field of the Invention

The field of the present invention is luggage.

2. Background

When traveling via airplane, ship, bus, or any other form of mass transportation, travelers are frequently faced with the task of locating and identifying their own luggage amongst other traveler's luggage, all the luggage being unorganized and scattered about a retrieval location. The multitude of mass produced luggage available in today's marketplace, much of which frequently looks the same, does not make the task of locating and identifying one's own luggage any easier. In fact, all too often nothing more than a small name tag differentiates one traveler's luggage from another's. Thus, the task of locating and identifying personal luggage amongst other luggage can often be a trying task because of the minute differences that often exist between different travelers' luggage.

### SUMMARY OF THE INVENTION

The present invention is directed towards a system for locating and identifying luggage. The system comprises a signaling unit and an identifying unit. The signaling unit includes an electromagnetic signal transmitter electronically coupled to a switch such that the signal transmitter generates an electromagnetic signal when the switch is actuated. The identifying unit is affixed to the luggage and includes an electromagnetic signal receiver for receiving the electromagnetic signal from the signal transmitter. Following receipt of the electromagnetic signal by the signal receiver, one or more additional elements of the identifying unit are electronically activated. Such elements enable the luggage to which the identifying unit is affixed to be located and identified.

In a first separate aspect of the present invention, the identifying unit includes a sound producing element electronically coupled to the signal receiver. Following receipt of the electromagnetic signals by the signal receiver, the sound producing element is activated to emit an identifying sound. The emitted sound may be of any sort, including a musical tune. The sound emitted by the identifying unit may thus be used to locate and identify the luggage to which the identifying unit is affixed. The luggage identifier may optionally include a memory element and a sound selection element, both electronically coupled to each other and to the sound producing element. A plurality of sounds may be stored using the memory element, with the sound selection element being employed to select one of the plurality of sounds for use as the identifying sound.

In a second separate aspect of the present invention, the identifying unit includes a light source electronically coupled to the signal receiver. Following receipt of the electromagnetic signals by the signal receiver, the light source is activated to emit light. The light radiating from the identifying unit may thus be used to locate and identify the luggage to which the identifying unit is affixed.

In a third separate aspect of the present invention, either of the foregoing aspects may be employed in combination.

Accordingly, it is an object of the present invention to provide a system for locating and identifying luggage. Other objects and advantages will appear hereinafter.

### BRIEF DESCRIPTION OF THE DRAWINGS

In the drawings, wherein like reference numerals refer to similar components:

FIG. 1 diagrammatically illustrates a system for locating and identifying luggage;

FIGS. 2A-C illustrate an application of the system of FIG. 1, wherein the identifying unit is incorporated into a piece of luggage; and

FIGS. 3A-C illustrate an application of the system of FIG. 1, wherein the identifying unit is incorporated into a luggage tag that may be affixed to a piece of luggage.

### DETAILED DESCRIPTION OF THE PREFERRED EMBODIMENTS

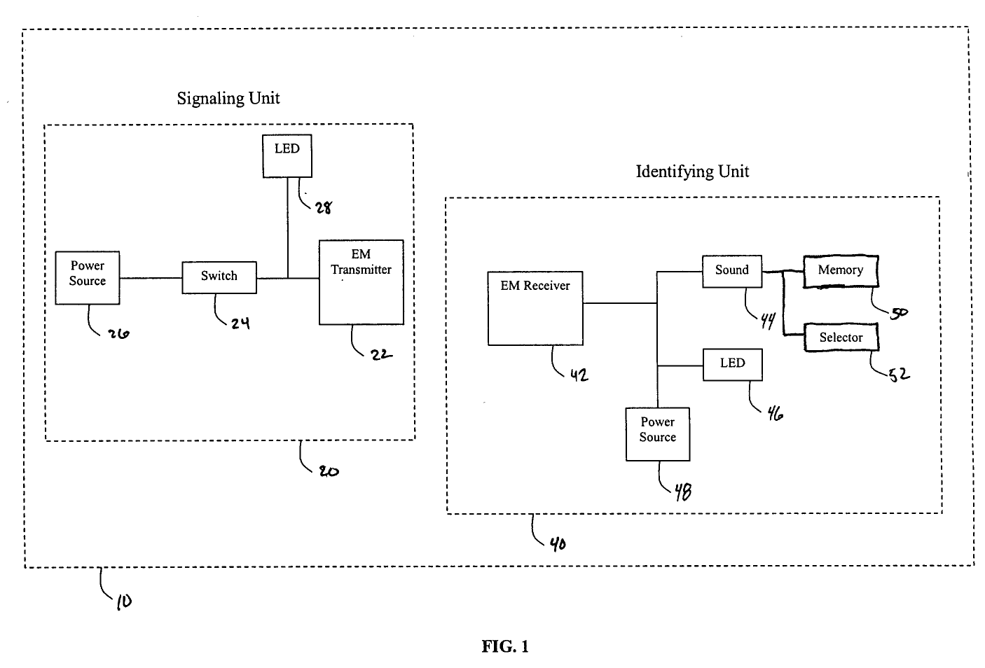

Turning in detail to the drawings, FIG. 1 diagrammatically illustrates a system 10 for locating and identifying luggage. The system 10 comprises a signaling unit 20 and an identifying unit 40. The signaling unit 20 includes an electromagnetic signal transmitter 22 electronically coupled to a switch 24, a power source 26, and a light emitting diode (LED) 28. The switch 24 is electrically disposed between the power source 26 and both the signal transmitter 22 and the LED 28 to regulate the power to the latter elements. Thus, when the switch 24 is actuated, power from the power source 26 is provided to the signal transmitter 22 and the LED 28. The LED 28 is provided as a visual indicator that the signaling unit 20 is operational. When power is provided to the signal transmitter 22, an electromagnetic signal is generated. The frequency of the electromagnetic signal may be any that is appropriate and/or desirable for the system 10 so that it functions as described herein.

The electromagnetic signal generated by the signal transmitter 22 is received by the identifying unit 40 when the identifying unit 40 is within the operational range of the signaling unit. Those skilled in the art will recognize that the operational range of the signaling unit 20 may vary and is largely dependent upon the design of and the amount of power provided to the signal transmitter 22. Such signal transmitters are well known in the art, as similar types of transmitters are commonly used to remotely activate equipment such as automobile alarms and garage door openers.

The identifying unit 40 includes an electromagnetic signal receiver 42 to receive the electromagnetic signal generated by the signal transmitter 22. Like the signal transmitter 22, such signal receivers are well known in the art and are also commonly incorporated into equipment such as automobile alarms and garage door openers for purposes of enabling the remote activation of these devices.

A sound producing element 44 and a light emitting diode (LED) array 46 are also electronically coupled to the signal receiver 42. These two elements serve as audio and visual identifiers, respectively, for the luggage to which the identifying unit 40 is affixed. A power source 48 is electronically coupled to the signal receiver 42, the sound producing element 42, and the LED array 46 to provide the power needed by these elements.

The sound producing element 46 is electronically activated by the signal receiver 42 following receipt of the electromagnetic transmission. Once the sound producing element 44 is activated, it produces an identifying sound. In order to limit the amount of power used by the sound producing element 44, following activation, the identifying sound is produced for a limited amount of time, which may vary as desired, before deactivating. Additionally, the identifying sound is produced at an appropriate volume so that the owner of the luggage to which the identifying unit 40 is affixed may locate and identify the luggage. Such a sound producing element is well known to those skilled in the art, and preferably comprises an electronic circuit (not shown) that is capable of storing and playing back the identifying sound through an electronically coupled speaker element (not shown).

The LED array 46 is also electronically activated by the signal receiver 42 following receipt of the electromagnetic transmission. Similar to the sound producing element 44, following activation, the LED array 46 emits light for a limited period of time before deactivating. Light emitted by the LED array 46 may be constant or intermittent, and may have any desired intensity. However, it is noted that for purposes of attracting the attention of a traveler to the identifying unit 40, and thus to the luggage to which the identifying unit 40 is affixed, brighter light is generally more desirable. LEDs are the preferred light source because of their lower power consumption, as compared to other types of light sources, however, any light source known to those skilled in the art may be employed.

To facilitate the location and identification of luggage, the each signaling unit 20 is preferably matched with an identifying unit 40. Such matching helps avoid confusion when many travelers are using personalized location and identification systems. The matching may be achieved by assigning an identifier sequence to each signaling unit 20, encoding the identifier sequence into the electromagnetic signal generated by the signaling unit 20, and verifying with the identifying unit 40 that the identifier sequence in the received electromagnetic transmission is the identifier sequence of the matched signaling unit 20. This comparison of the identifier sequence is performed before the audio and/or visual elements of the identifying unit 40 are activated. Other means of creating such “matched pairs” may also be employed.

A single signaling unit may also be advantageously matched with two or more identifying units in the same manner. A traveler having multiple pieces of luggage that need to be located and identified would find such matching desirable so that only a single signaling unit need be retained during travel.

FIG. 1 further illustrates the optional memory element 50 and sound selection element 52, both of which are electronically coupled to the sound producing element 44. With these optional elements incorporated into the identifying unit 40, a plurality of sounds may be stored by the memory element 50. The sound selection element 52 serves as an interface between the memory element 50 and the sound producing element 44 such that, by using the sound selection element 52, one of the plurality of sounds stored by the memory element 50 may be selected as the identifier sound. The selected identifier sound is emitted by the sound producing element 44 after the identifier unit 40 receives the electromagnetic signal from the signaling unit 20. The sound selection element 52 may be, for example, a simple row of switches, the positions of which determine the identifier sound, a numeric keypad, which may be used to select the identifying sound if each of the plurality of sounds are associated with a unique reference number, or any other type of input that is appropriate or desirable for selecting the identifier sound from amongst the plurality of sounds.

The memory element 50 may be any type of audio storing medium and/or device with which sound may be stored in a format that is compatible with the sound producing element 44. A memory element 50 that statically stores the plurality of sounds in a digital format without the need of power to maintain the sounds in the memory is preferred. When using a static memory, the sound producing element 44 may access the selected identifying sound directly from the static memory.

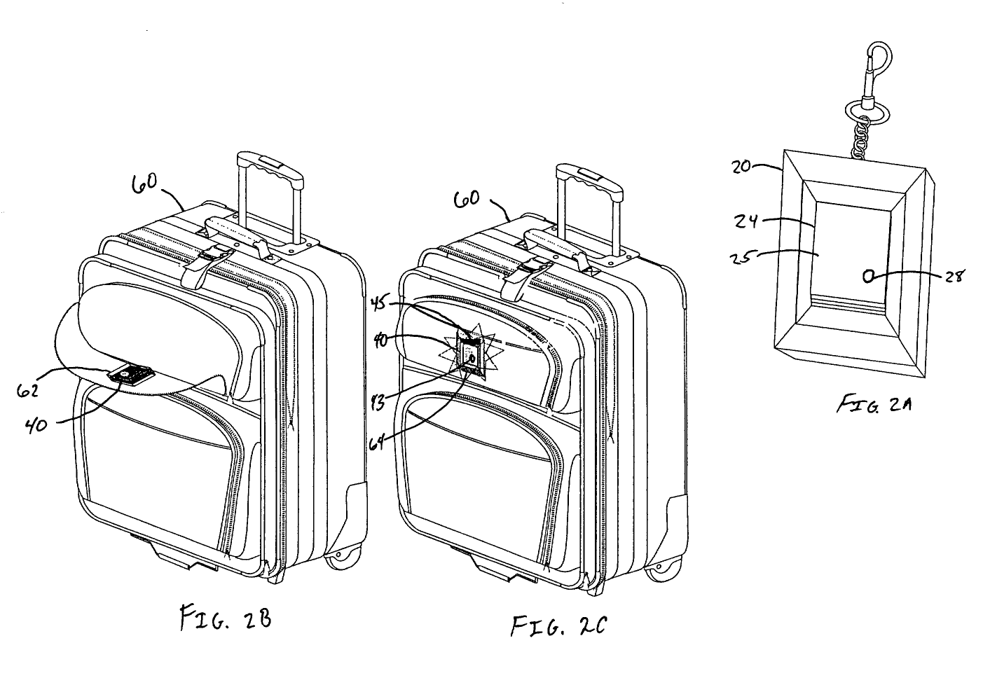

FIGS. 2A-C illustrate a first embodiment of a locating and identifying system as described herein. FIG. 2A illustrates the signaling unit 20, which is small, portable, and designed so that it may be conveniently carried on a traveler's key chain. The switch 24 is a single pole single throw (SPST) style switch that has a large face 25 exposed on one side of the signaling unit 20. The LED 28 is set into the face 25 of the switch 24 so that it is easily visible when the switch 24 is depressed. FIG. 2B shows the identifying unit 40 placed in an interior pocket 62 of a piece of luggage 60. An interior pocket, as opposed to an exterior pocket, is preferred to avoid loss of the identifying unit 40 while the luggage is in transit.

FIG. 2C shows the exterior of the luggage 60. The interior pocket 62 is at least partially exposed to the exterior of the luggage 60 and includes a protective covering 64, such as a mesh or plastic, that retains the identifying unit 40 in the pocket 62 while not significantly blocking any audio or visual signals emitted from the identifying unit 40. The identifying unit 40 includes a small aperture 43 through which the identifying sound is emitted when the sound producing element is activated. The identifying unit 40 also includes a large face 45 which is illuminated by the LED array when activated. The aforementioned features of the identifying unit 40 and the luggage 60 serve to make the audio and visual signals more noticeable to travelers when the signals are activated.

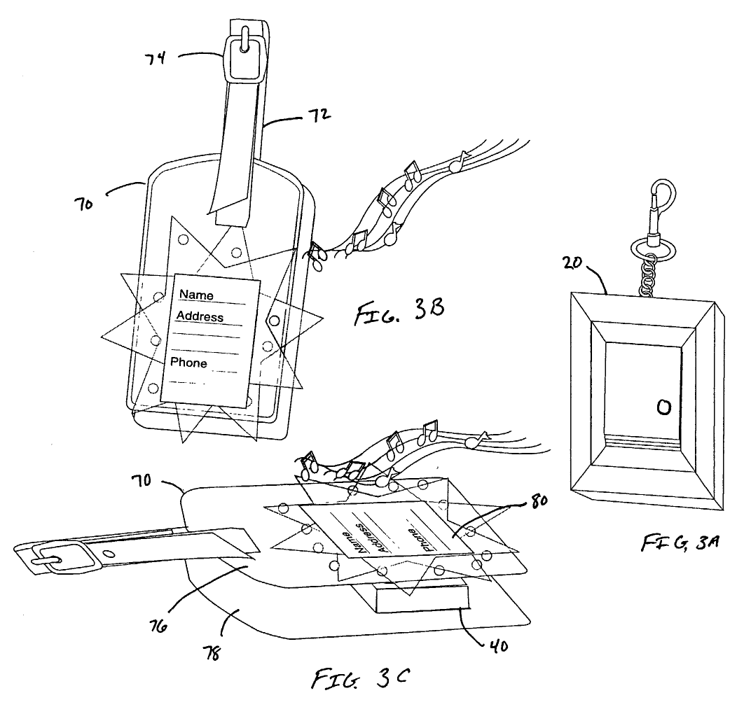

FIGS. 3A-C illustrate a second embodiment of a locating and identifying system as described herein. FIG. 3A illustrates the signaling unit 20, which is small, portable, and designed so that it may be conveniently carried on a traveler's key chain. The other features of the signaling unit 20 are the same as those described in connection with FIG. 2A. FIGS. 3B and 3C illustrate the identifying unit 40 incorporated into a luggage tag. The luggage tag 70 includes a strap 72 with an appropriate fastener 74 so that the luggage tag 70 may be easily affixed to and removed from luggage. The identifying unit 40 is securely affixed between a front panel 76 and a rear panel 78 of the luggage tag 70. At least part of the identifying unit 40 is left exposed so that audio signals generated by the identifying unit are more noticeable to travelers. The front panel 76 of the luggage tag includes name plate 80. The name plate 80 is formed of a semi-translucent material, such as an opaque paper or plastic, that may be written on yet still allow the LED array of the identifying unit 40 to be noticeable when activated.

Thus, a system for locating and identifying luggage is disclosed. While embodiments of this invention have been shown and described, it will be apparent to those skilled in the art that many more modifications are possible without departing from the inventive concepts herein. For example, those skilled in the art will recognize that the signaling unit 20 and identifying unit 40 illustrated in FIG. 1 are but simplified representations of the actual circuit designs and that many variations on the placement of the actual electronic sub-assemblies diagrammatically depicted in FIG. 1 are possible while still maintaining the functionality of each unit. The invention, therefore, is not to be restricted except in the spirit of the following claims.

What is claimed is:

1. A system for locating and identifying luggage comprising:
a signaling unit including an electromagnetic signal transmitter electronically coupled to a switch, wherein the signal transmitter generates an electromagnetic signal when the switch is actuated; and
an identifying unit affixed to the luggage including
an electromagnetic signal receiver for receiving the electromagnetic signal from the signaling unit; and
a sound producing element electronically coupled to the signal receiver such that the sound producing element emits an identifying sound following receipt of the electromagnetic signal by the signal receiver.

2. The system of claim 1, wherein the identifying sound comprises a musical tune.

3. The system of claim 1, wherein the identifying unit further includes a light source electronically coupled to the signal receiver such that the light source emits light following receipt of the electromagnetic signal by the signal receiver.

4. The system of claim 3, wherein the light source comprises a light emitting diode.

5. The system of claim 3, wherein the light source intermittently emits light.

6. The system of claim 1, wherein the identifying unit further includes a memory element electronically coupled to the sound producing element, the memory element storing a plurality of sounds; and
a sound selection element electronically coupled to the memory element and to the sound producing element to select one of the plurality of sounds as the identifying sound.

7. A system for locating and identifying luggage comprising:
a signaling unit including an electromagnetic signal transmitter electronically coupled to a switch, wherein the signal transmitter generates an electromagnetic signal when the switch is actuated; and
an identifying unit affixed to the luggage including
an electromagnetic signal receiver for receiving the electromagnetic signal from the signaling unit; and
a light source electronically coupled to the signal receiver such that the light source emits light following receipt of the electromagnetic signal by the signal receiver.

8. The system of claim 7, wherein the light source comprises a light emitting diode.

9. The system of claim 7, wherein the light source intermittently emits light.

10. A system for locating and identifying luggage comprising:
a signaling unit including an electromagnetic signal transmitter electronically coupled to a switch, wherein the signal transmitter generates an electromagnetic signal when the switch is actuated;
at least one piece of luggage; and
an identifying unit affixed to the luggage including
an electromagnetic signal receiver for receiving the electromagnetic signal from the signaling unit; and
a sound producing element electronically coupled to the signal receiver such that the sound producing element emits an identifying sound following receipt of the electromagnetic signal by the signal receiver.

11. The system of claim 10, wherein the identifying sound comprises a musical tune.

12. The system of claim 10, wherein the identifying unit further includes a light source electronically coupled to the signal receiver such that the light source emits light following receipt of the electromagnetic signal by the signal receiver.

13. The system of claim 12, wherein the light source comprises a light emitting diode.

14. The system of claim 12, wherein the light source intermittently emits light.

15. The system of claim 10, wherein the identifying unit further includes
a memory element electronically coupled to the sound producing element, the memory element storing a plurality of sounds; and
a sound selection element electronically coupled to the memory element and to the sound producing element to select one of the plurality of sounds as the identifying sound.
